(19) United States
(12) Patent Application Publication
(10) Pub. No.: US 2024/0219549 A1
(43) Pub. Date: Jul. 4, 2024

(54) WIRELESS HOME IDENTIFICATION AND SENSING PLATFORM

(71) Applicants: THE REGENTS OF THE UNIVERSITY OF COLORADO, A BODY CORPORATE, Denver, CO (US); IOWA STATE UNIVERSITY RESEARCH FOUNDATION, INC., Ames, IA (US); UNIVERSITY OF WASHINGTON, Seattle, WA (US); ALLIANCE FOR SUSTAINABLE ENERGY LLC, Golden, CO (US)

(72) Inventors: Gregor P. HENZE, Boulder, CO (US); Joshua R. SMITH, Seattle, WA (US); Soumik SARKAR, Ames, IA (US); Anthony J. FLORITA, Goldon, CO (US); Margarite JACOBY, Boulder, CO (US); Mohamadtaghi Katanbaf NEZHAD, Seattle, WA (US); Ali SAFFARI, Seattle, WA (US); Sin Yong TAN, Ames, IA (US)

(21) Appl. No.: 18/557,369

(22) PCT Filed: Apr. 26, 2022
(86) PCT No.: PCT/US2022/026389

§ 371 Date: Oct. 26, 2023

Related U.S. Application Data
(60) Provisional application No. 63/180,643, filed on Apr. 27, 2021.

(51) Int. Cl. G01S 13/04; G01S 13/86

(52) U.S. Cl. CPC G01S 13/04; G01S 13/86

(57) ABSTRACT

An integrated occupancy sensing system includes one or more radio frequency identification (RFID) sensor nodes and one or more base station units. Each of the one or more RFID sensor nodes includes at least one of (1) an image sensor, (2) an acoustic energy sensor, (3) a temperature sensor, (4) an illuminance sensor, or (5) a relative humidity sensor. Each of the one or more base station units is configured to be connected to a power source to emit a continuous wave carrier signal and to receive a reflected signal. Each of the one or more RFID sensor nodes is configured to receive and reflect the continuous wave carrier signal. In response to receiving the reflected signal from the one or more RFID sensor nodes, at least one of the base station units is configured to infer the likelihood of human occupancy in the building.

### CROSS-REFERENCE TO RELATED APPLICATIONS

This application claims priority to U.S. Provisional Application Ser. No. 63/180,643, entitled “WIRELESS HOME IDENTIFICATION AND SENSING PLATFORM FOR ENERGY REDUCTION,” filed Apr. 27, 2021, which application is incorporated by reference herein in its entirety.

### GOVERNMENT RIGHTS

This invention was made with government support under grant number DE-AR0000938 awarded by the U.S. Department of Energy. This invention was also made with government support under Contract No. DE-AC36-08GO28308 awarded by the United States Department of Energy to Alliance for Sustainable Energy, LLC, the Manager and Operator of the National Renewable Energy Laboratory. The government has certain rights in the invention.

### BACKGROUND

Occupancy sensors are a type of indoor motion-detecting device that can be used to detect the presence of a person. The occupancy sensors may be used to automatically control lights or temperature or ventilation systems. If no motion is detected, it is assumed that the space is empty, and thus does not need to be lit, and lights, air conditioning and/or heating may be turned off. Alternatively, or in addition, the occupancy sensors may also be used in combination with a security system. For example, if the occupancy sensor detects motion when no one is supposed to be home, there may be an unwanted intruder.

Existing occupancy sensors are often connected to a power source and use infrared, ultrasonic microwave, or other technology to detect occupancy. Such existing occupancy sensor can only be placed at an electrical outlet, or additional wiring may be required to place them at a location where an electrical outlet is not available.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to an integrated occupancy sensing platform or system (hereinafter also referred to as “the system”). The integrated occupancy sensing system comprises a radio-frequency identification (RFID) sensor network coupled with multimodal sensor fusion that leverages the spatiotemporal interactions of all dynamic systems and signals found in a residential building for high accuracy occupancy detection.

In some embodiments, the RFID sensor network includes a power transmit/receive reader, a sensor node (hereinafter also referred to as a base station unit), and one or more sensing elements equipped with image sensors and/or acoustic energy sensors (hereinafter also referred to as sensor nodes). The sensor node directly reflects the radio signal emitted from the power transmit/receive reader. Each of the sensor nodes is combined with one or more temperature, humidity, and/or illuminance as environmental modalities. The sensors can be positioned up to 16 feet away from the transmitter, which enables multimodal sensor elements that require no wiring.

In some embodiments, at least some of the RFID sensors are coupled to a photovoltaic cell configured to harvest at least two sources of energy, including (but not limited to) radio frequency and light. The photovoltaic cell enables a higher data transfer rate and longer distance between the reader and a sensor.

Privacy and power are preserved by collecting and communicating image and acoustic energy information in a restricted fashion. In some embodiments, the energy consumption to capture a single frame can be 150 microjoules, and power available at 16 feet can be 15 microwatts. As such, the system allows 1 frame of image to be captured every 10 seconds.

In some embodiments, the sensor data generated by the temperature sensor, the illuminance sensor, and/or the relative humidity sensor are also referred to as environmental data. The environmental data is analyzed using one or more spatiotemporal pattern networks (STPN). An STPN is configured to exploit the spatiotemporal interactions of the physical sensor response in the home due to human activity to capture and harness all pairwise Granger-casual relationships. In some embodiments, image data can be processed with the help of convolutional neural networks to discern occupied scenes from unoccupied scenes. In some embodiments, the acoustic energy data undergoes several feature extraction steps before being analyzed by a random forest classification model.

As such, multiple individual occupancy inferences can be obtained based on environmental, acoustic energy, and image sensors. In some embodiments, the multiple individual occupancy inferences can then be fused together using an overarching whole-house occupancy inference algorithm to determine an overarching whole-house inference. In some embodiments, the overarching whole-house occupancy inference algorithm is based on autoregressive logistic regression, which considers past occupancy predictions along with current sensor modality-level inferences as well as time of-day and day type indicators to achieve a high-accuracy occupancy detection with minimal intrusion, cost, and implementation burden.

In some embodiments, all or substantially all the sensor data streams, including (but not limited to) images, acoustic energy, and environmental variable features, are fed into a sensor fusion framework based on a diverse set of inference algorithms.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments, which are illustrated in the appended drawings. Understanding that these drawings depict only typical embodiments and are not, therefore, to be considered to be limiting in scope, embodiments will be described and explained with additional specificity and details through the use of the accompanying drawings.

FIG. 1 illustrates a schematic of a system for wireless home identification and sensing.

FIG. 2 illustrates a home floor plan with a wireless home identification and sensing platform.

FIG. 3 illustrates a flowchart of a spatiotemporal pattern network configured to train one or more spatiotemporal pattern network models for inferring occupancy.

FIG. 4 illustrates flowchart of a neural network configured to train one or more AI models for inferring occupancy.

FIG. 5 illustrates a random forest classification configured to train one or more random forest models for inferring occupancy.

FIG. 6 illustrates a flowchart for a method for wireless home identification and sensing.

### DETAILED DESCRIPTION

The embodiments described herein are related to an integrated occupancy sensing platform or system (hereinafter also referred to as “the system”). There is a need for high-quality human presence detection (replacing low-quality motion sensing) for emerging applications in smart thermostats, flexible energy systems with high-renewable energy share, smart grids, and smart devices for maintaining indoor environmental quality (IEQ) and health. The difficulties of such a high-quality human presence detection platform include (but are not limited to) (1) achieving high accuracy, i.e., low false alarms and/or pet distinction for providing high savings and user acceptance, (2) implementing local wireless, such as providing an information filter to the grid for privacy preservation, and (3) battery-free power and communications for robustness and simplicity.

The integrated occupancy sensing system disclosed herein overcame the above-described difficulties, by implementing local wireless and battery-free radio-frequency identification (RFID) sensors while achieving high accuracy. The integrated occupancy sensing system comprises a radio-frequency identification (RFID) sensor network coupled with multimodal sensor fusion that leverages the spatiotemporal interactions of all dynamic systems and signals found in a residential building for high accuracy occupancy inference.

In some embodiments, the RFID sensor network includes a power transmit/receive reader, a base station, and one or more RFID sensor nodes equipped with image sensors and/or acoustic energy sensors (also referred to as “sensor nodes”). The sensor nodes reflect the radio signal emitted from the power transmit/receive reader. Each of the sensor nodes is combined with one or more temperature, humidity, and/or illuminance as environmental modalities. The sensors can be positioned up to 16 feet away from the transmitter, which enables multimodal sensor elements that require no wiring.

In some embodiments, at least some of the RFID sensors is coupled to a photovoltaic cell configured to harvest at least two sources of electromagnetic energy, including (but not limited to) radiofrequency and light. The power from the photovoltaic cell may enable a higher data transfer rate and longer distance between the reader and a sensor.

In some embodiments, privacy and power are preserved by collecting and communicating image and acoustic energy information in a restricted fashion. In some embodiments, the energy consumption to capture a single frame can be 150 microjoules, and power available at 16 feet can be 15 microwatts. As such, the system allows 1 frame of image to be captured every 10 seconds.

In some embodiments, all or substantially all the sensor data streams, including (but not limited to) images, acoustic energy, and environmental variable features, feed a sensor fusion framework based on a diverse set of inference algorithms. Such sensor data streams are also referred to as environmental data. The environmental data is analyzed using one or more spatiotemporal pattern networks (STPN). An STPN is configured to exploit the spatiotemporal interactions of the physical sensor response in the home due to human activity to capture and harness all pairwise Granger-casual relationships. In some embodiments, image data can be processed with help of convolutional neural networks to discern occupied scenes from unoccupied scenes. In some embodiments, the acoustic energy data undergoes several feature extraction steps before being analyzed by a random forest classification model.

As such, multiple individual occupancy inferences can be obtained based on environmental, acoustic energy, and image sensors. In some embodiments, the multiple individual occupancy inferences can then be fused together using an overarching whole-house occupancy inference algorithm to determine an overarching whole-house inference. In some embodiments, the overarching whole-house occupancy inference algorithm is based on autoregressive logistic regression, which considers past occupancy predictions along with current sensor modality-level inferences as well as time of day and day type indicators to achieve a high-accuracy occupancy detection with minimal intrusion, cost, and implementation burden.

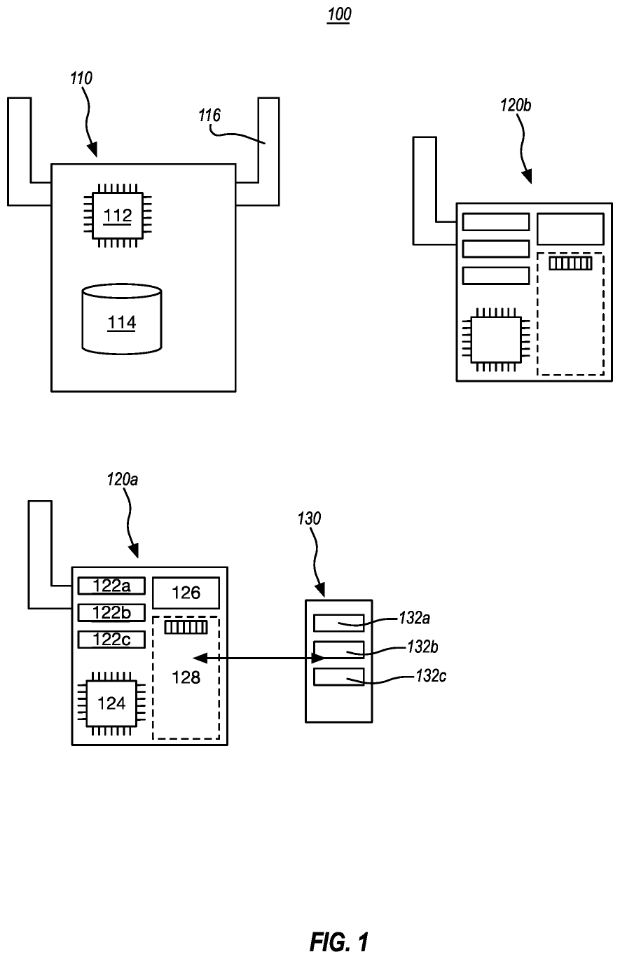

FIG. 1 illustrates a schematic of a system 100 for wireless home identification and sensing. The system includes at least one base station unit 110 (also referred to herein as a “base station”) that comprises at least one processor 112, computer storage media 114, and one or more antennas 116. In at least one embodiment, the base station unit 110 is configured to be connected to a power source, such as an outlet. The antennas may be utilized to transmit and receive data, as well as to transmit and receive power. For example, when the at least one base station units 110 is connected to a power source, the at least one base station unit is configured to emit a continuous wave carrier signal.

The system 100 further includes example RFID sensor nodes 120a, 120b. One will appreciate that two RFID sensor nodes 120a, 120b are shown for the sake of example, and that in alternative embodiments any number of sensor nodes 120 may be included within the system 100. An exemplary RFID sensor node 120a may comprise a motherboard the holds various sensors 122(a-c), including but not limited to 1) an image sensor, (2) an acoustic energy sensor, (3) a temperature sensor, (4) an illuminance sensor, and/or (5) a relative humidity sensor. The exemplary RFID sensor node 120a may also include at least one processor 124, a power unit 126 (such as a photovoltaic cell and/or a battery), and a daughterboard connection area 128.

The RFID sensor nodes 120 are configured to receive and reflect the continuous wave carrier signal emitted by the at least one base station unit 110. The at least one base station unit is also configured to receive the reflected signal from the one or more RFID sensor nodes. Based on the reflected signal, the at least one processor 112 at the base station unit 110, is able to infer a likelihood of human occupancy within the building that contains the RFID sensor nodes 120 and the base station 110.

In some embodiments, the system includes multiple base station units. Each of the base station units is plugged into a wall at a different location, configured to emit a continuous wave of about 915 MHz carrier signal. This carrier signal provides power to the sensor nodes. The sensor nodes communicate with the base station units by reflecting or backscattering the carrier signals. For example, a sensor node may receive and reflect a carrier signal from a particular base station unit. The reflected signals may then be received by another base station unit among the multiple base station units via conventional radio.

In some embodiments, the sensor nodes can be powered by a combination of harvested continuous wave carrier signals (from the base station units) and energy harvested by photovoltaic cells. Receiving power from both the continuous wave carrier signal and photovoltaic cells may allow the sensor nodes to broadcast a stronger signal back to the base station 110 for processing. In additional or alternative embodiments, the sensors nodes may receive power only from the continuous wave carrier signal emitted by the at least one base station 110. In some embodiments, the sensor nodes may be battery-free, such that the RFID sensor node does not include nay energy storage component. In some embodiments, the sensor nodes may include a rechargeable energy storage, such as (but not limited to) a capacitor or a rechargeable battery.

In some embodiments, each of the sensor nodes 120 includes a motherboard that is identical across all sensor nodes. The motherboard is configured to provide power and communication to the various sensors 122(a-c). In some embodiments, the motherboard is coupled with one or more daughterboards 130, each of which provides one or more specific sensing modalities, e.g., (1) images or (2) acoustic energy. For example, a daughterboard 130 may have various additional sensor units 132(a-c) and/or processing chips that can be integrated into the sensor nodes 120. This ability to add sensing modalities to the sensor nodes 120 allows an end user to customize the overall system 100. In some embodiments, the motherboard and daughterboard(s) are integrated into a single unit.

In some embodiments, electrical device activities may also be sensed at one of the plugged-in base station units 110. For example, the base station units 110 may be configured to monitor the electric distribution system within a building to provide an additional signal about human activity. For example, when a user activates an electrical device, such as a vacuum cleaner, within a household, the electrical device may introduce an electromagnetic interference signal within the electric distribution system of the building. The base station 110 may comprise a set of stored electromagnetic interference signal fingerprints within its computer storage media 114. The base station 110 may utilize the one or more processors 112 and the fingerprints and/or a neural network to map the electromagnetic interference signal to human activity. Further, in some embodiments, the base station 110 maps the electromagnetic interference signal to a particular appliance or electrical device using the electromagnetic interference signal fingerprints and/or the neural network. Accordingly, the system 100 is able to more accurately infer the likelihood of human occupancy based on the electromagnetic interference signal.

In some embodiments, for reasons of privacy, data compression, and/or power-saving, the acoustic energy sensor may be configured to directly measure features of the audio signal, instead of providing complete human-understandable audio recordings. In some embodiments, the acoustic sensor may use a rectifier circuit to measure total acoustic energy in a particular time window (e.g., 100-millisecond time window). In some embodiments, the time window may be determined and/or adjusted by the time constant of the low pass filter following the rectifier. Alternatively, in some embodiments, the audio signal may first be broken into frequency bands by one or more passive (i.e., zero power) analog filters before being rectified. In some embodiments, one or more acoustic energy features can be directly measured by low-power analog hardware. The one or more acoustic energy features are directly usable by one or more audio processing machine learning algorithms.

In some embodiments, also for reasons of privacy, data compression, and/or power-saving, the image sensor may provide features of the scene rather than a human-interpretable image. In some embodiments, the features may include “superpixels,” which are averages of multiple pixels that can directly be measured by appropriately designed pixel readout circuitry. In some embodiments, an image sensor may also be configured to identify humans using more complex space-time features. In some embodiments, specific sub-images, superpixels, or other image features, instead of full images, may be provided.

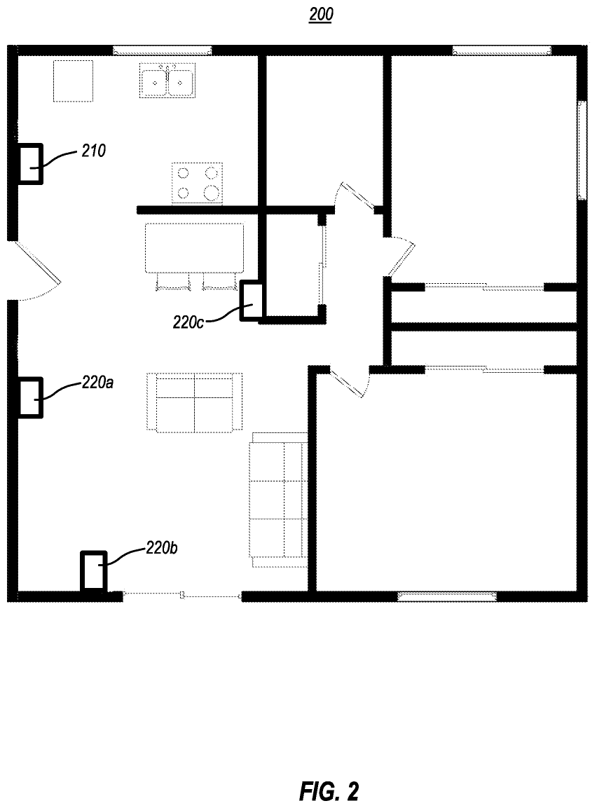

FIG. 2 illustrates a home floor plan 200 with a wireless home identification and sensing platform. The home floor plan 220 shows a base station unit 210 and three RFID sensor nodes 220(a-c) positioned throughout the house. One will appreciate that the depicted configuration is provided for the sake of example and explanation, and does not limit the number, location, or configuration of the base station unit 210 or the associated RFID sensor nodes 220(a-c).

A custom-designed residential wireless home identification and sensing system is built to collect data from an environment. In some embodiments, a diversity of sensor types is preferred. However, the exact number of each type depends on the size and layout of the space. A complete wireless home identification and sensing system may contain at least one of each of the following sensor types: (1) an acoustic energy sensor (e.g., a microphone), (2) an image sensor (e.g., a camera), (3) a temperature sensor, (4) a relative humidity sensor, and (5) an illuminance sensor for detecting light levels.

Except for image sensors, multiple sensors of the same type are not necessary in homes with only one primary living space, although duplicates can be used for the sake of redundancy and/or accuracy. Note, a “living space” is defined as a set of non-private rooms that are close together, such as a kitchen, a living room, and a dining room, in a same part of the house. The living space does not have to be a single large room. In some embodiments, it is preferred to place one or more image sensors in each of main areas that people spend time in within the living space. For homes with multiple distinct living spaces, it is preferred to install a system per living space.

In some embodiments, sensors are preferred to be placed about five feet above the ground, and/or in a same vertical plane as the base station units. A temperature sensor, a relative humidity sensor, and an illuminance sensor can be collocated with an image sensor or an acoustic energy sensor for reducing hardware redundancy.

In some embodiments, a preferred location for an acoustic energy sensor is in a kitchen. When the acoustic energy sensor is placed in a kitchen, the sensor often can also capture sound from the rest of the living space, and no additional acoustic energy sensors are needed. However, if the rooms are closed off or far apart from one another, an additional acoustic energy sensor may be preferred to be placed in the living room or dining room.

In some embodiments, a preferred location for an image sensor is in both the kitchen and the dining room. Depending on the layout of the living room, one or more image sensors are preferred to be placed therein to fully capture the space visually. Locations with abundant natural light, especially direct sunlight, or harsh shadows should be avoided. Image sensors should also not be directly facing large windows or televisions, and/or direct artificial light sources, such as frequently used lamps. If possible, image sensors are preferred to be placed in locations that have a view containing minimal background activity, such as straight on views of simple walls that people pass in front of frequently, or view of couches.

In some embodiments, a preferred location for temperature sensors and/or relative humidity sensors is a central location away from air supply locations (e.g., air conditioning vent). Additionally, the temperature sensors and/or relative humidity sensors are preferably not placed anywhere that may be significantly impacted by outside conditions, such as next to a window. For example, a preferred location may be an interior wall that is centrally located.

In some embodiments, a preferred location for illuminance sensors is next to a temperature sensor and/or a relative humidity sensor. Alternatively, or in addition, in some embodiments, an illuminance sensor is preferred to be placed in a place where artificial lights are used the most.

For each type of sensed variable (also referred to as sensor modality), different models and feature extraction techniques may be implemented to obtain the desired occupancy detection performance. In some embodiments, to ensure that the models are implementable on an embedded system with limited memory and computation resources, the models are selected with two important aspects, namely, model size and inference speed.

Environmental sensor data are time-series data that keeps track of the temperature, relative humidity, and illuminance in a monitored area. For these time series data, a spatiotemporal pattern network (STPN) approach is used to capture the patterns, construct the states, and ultimately, output the occupancy probability.

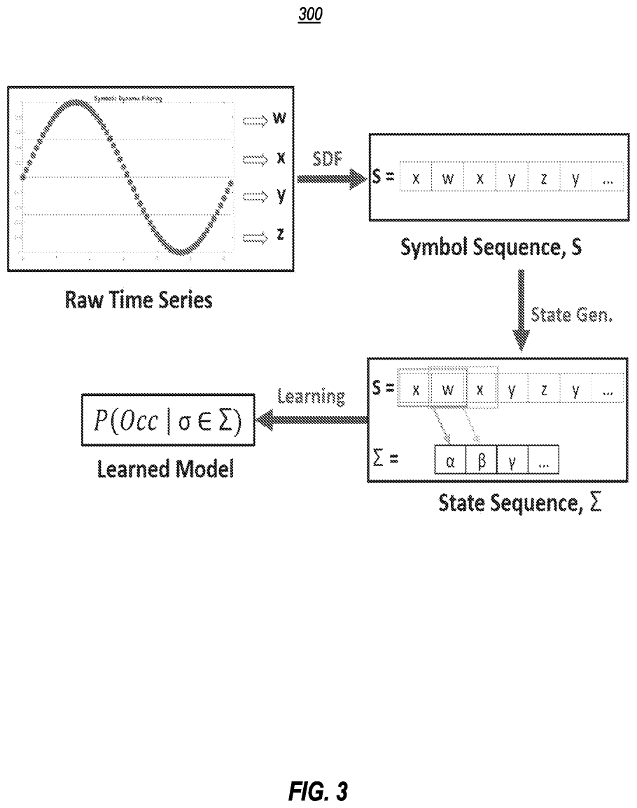

FIG. 3 shows an end-to-end training pipeline 300 for an STPN. The pipeline begins on the top left with a discretization of raw time series data using symbolic dynamic filtering (SDF) technique. The SDF technique translates the raw time-series data from the continuous space to a discrete space. Each range of continuous value constitutes a bin, that is represented by a unique symbol (e.g., w, x, y, z). Each data point is then replaced by one of these unique symbols corresponding to their value to form a symbol sequence, S.

In the next step, a state is generated using a defined number of consecutive historical symbols in the symbol sequence. Each unique combination of the historical symbols will generate a unique state (e.g., state α is constructed with symbols {x,w}, and state β is constructed with symbols {w,x}). Depending on the desired number of historical symbols, a fixed-size sliding window will slide across the symbol sequence to generate a state sequence, Σ. Essentially, each state in the state sequence now represents an embedding of the current data and a defined window of historical data. Using this state sequence, the relational pattern (RP) from the state sequence to the occupancy status is learned by computing the transition probability from a state to the occupancy status (occupied or vacant). This learned model is then used in the inferencing stage to output the occupancy probability corresponding to the input state.

Image data includes indoor residential images that are designed to capture the human figures or human presence in a field of view of an image sensor. In order to detect a human in an image, a convolutional neural network (CNN) can be implemented.

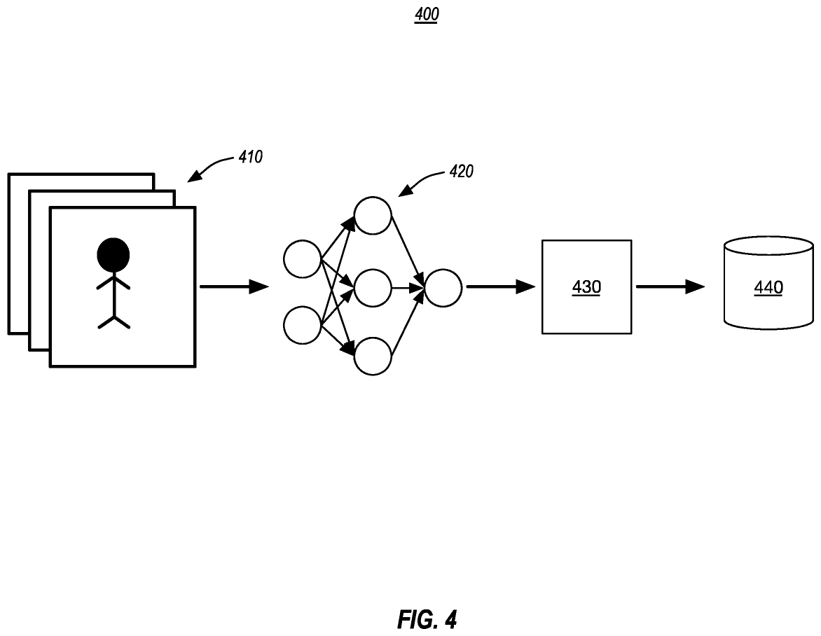

FIG. 4 illustrates flowchart 400 explaining the training and implementation of the CNN model for occupancy detection. From the left of FIG. 4, the flowchart begins with the annotated camera images 410 as the training data to the neural network. Images collected using the camera nodes are labeled and annotated with bounding boxes around the humans. Multiple data augmentations techniques such as brightness varying, flipping, and mosaic data augmentations are performed to generate a richer variation of the images. These data augmentations procedures are essential to enhance the robustness of the trained model to various scenarios such as different illuminance and human position in the images.

In the next step, these images are then fed into the CNN 420 for model training. After training the model, the model weights and architecture are saved for future inferencing purposes. However, before deploying the model to the embedded system 440 (here, based on Raspberry Pi), the model weights are converted into a Tensorflow Lite (TF-Lite) format 430. There are primarily two reasons for this conversion: First, this conversion reduces the size of the model weights, and secondly, it allows the use of a TF-Lite Interpreter for inferencing on an embedded system. Unlike other heavy deep learning frameworks, TF-Lite Interpreter is a lightweight model interpreter library dedicated to model inferencing on embedded systems with limited computational resources. This effectively reduces the required memory consumption on the embedded system as it eliminates the need to install the entire deep learning library solely for inferencing purposes.

Audio data reflects the amplitude of the sound captured in each designated area where the acoustic energy sensors are placed. Utilizing feature extraction techniques, distinctive acoustic energy patterns can be extracted from the audio data and used to train a random forest classification model for occupancy detection.

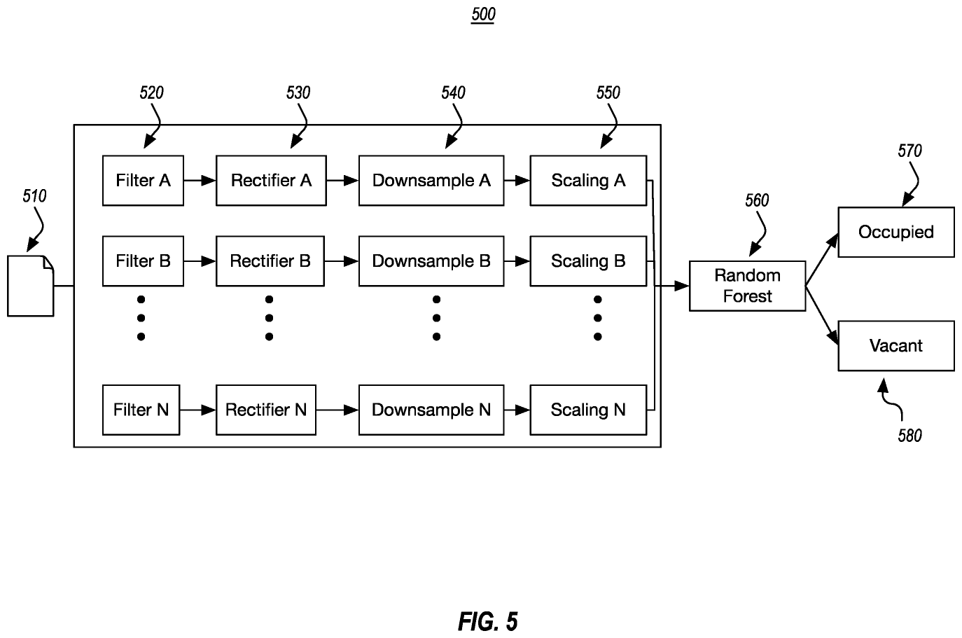

FIG. 5 illustrates a flowchart 500 explaining the feature extraction process of a raw audio clip 510 and the random forest classification model for training and inferencing. As illustrated, upon collecting the raw audio data, a series of feature extraction procedures are implemented to extract useful acoustic energy features from the audio data. First, a number of bandpass filters 520, each with different frequency ranges, are applied to the raw audio data to separate and capture the patterns in various frequencies. After this filtering step, the following procedures branch out, and similar operations are applied for each filtering output.

In the next, a full-wave rectification 530 is applied on each of the filtered data to produce non-negative values, and the data were downsampled 540 to reduce the data size. Finally, a linear scaling 550 was performed to scale the data into the [0,1] range. Linear scaling is a common machine learning preprocessing step that ensures the extracted acoustic energy features maintain their patterns in each filter and contribute equally to the model learning process. This linear scaling concludes the feature extraction process, and the extracted acoustic energy features are fed into a random forest classification model 560 for training. Upon completing the training, the model is saved for deployment. In the inferencing process, the trained random forest model will take in the extracted features of acoustic energy and outputs an occupied 570 or vacant 580 status.

Finally, the whole-house occupancy detection algorithm is implemented to combine the individual underlying inference modalities for acoustic energy, images, and the environmental sensors described above together with previous occupancy predictions in a logistic regression model. In some embodiments, the whole-house occupancy detection algorithm is an autoregressive logistic regression model with exogenous variables.

Logistic regression is a binary classification method, which uses a sigmoid, or logit function, to predict probabilities of a binary occurrence (in this case, whole house occupancy). The probabilities output by the model are rounded down to 0 (meaning the house is vacant) or up to 1 (meaning the house is occupied), using an adjustable cut-off threshold.

The autoregressive portion of the algorithm refers to past predictions of occupancy that are used in the model to predict current occupancy. Lags of up to eight hours are considered, and for each discrete hour lag, m, the mean occupancy predictions over a one-hour period, from m hours ago, are included as inputs to the model.

The exogenous portion of the algorithm refers to additional variables (non-autoregressive ones) that are used as inputs to the models. These include acoustic energy, images, indoor temperature, indoor relative humidity, room illuminance, time of day, and whether it is a weekend or not.

The autoregressive logistic regression in is expressed in the equation 1 below:

$$log \frac{P ( {y}_{t} )}{1 - P ( {y}_{t} )} = {β}_{0} + {\sum }_{m = 1}^{M} [ {β}_{t - K \cdot m} \cdot {y}_{t - K \cdot m} ] + {ϕ}_{A} \cdot {\hat{y}}_{A , t} + {ϕ}_{I} \cdot {\hat{y}}_{I , t} + {ϕ}_{T} \cdot {\hat{y}}_{T , t} + {ϕ}_{R} \cdot {\hat{y}}_{R , t} + {ϕ}_{W} \cdot {\hat{y}}_{W , t} + {ϕ}_{H} \cdot {\hat{y}}_{H , t}$$

Where the variables represent:
βᵢ=Auto-regressive model coefficients
ϕᵢ=Exogenous model coefficients
yₜ=Occupancy prediction at current time-step, t
K=Number of time-steps per hour (12)
y_{t-K·m}=Predicted whole-house occupancy m hours in the past (aka the lagged variables)
M=Total length of history considered in hours (8)
m=Number of hours back at the particular time-step
ŷ_{A,t}=Acoustic occupancy inference at the current time-step, t
ŷ_{l,t}=Image occupancy inference at the current time-step, t
ŷ_{T,t}=Temperature occupancy inference at the current time-step, t
ŷ_{R,t}=Relative humidity occupancy inference at the current time-step, t
ŷ_{L,t}=Illuminance occupancy inference at the current time-step, t
ŷ_{W,t}=Binary weekday-weekend flag
ŷ_{H,t}=Hour of day (periodic feature)

Given that each home may have multiple sensor nodes, and therefore might have multiple streams of the same sensing modality, a modality-level occupancy inference is determined by finding the maximum value of that modality, across all collected streams of the same modality. For additional robustness, encoded features, such as the hour-of-day periodic time feature (using sine and cosine functions) is included in the autoregressive logistic regression algorithm, which provides the algorithm with information that the event is periodic. Additionally, to account for traditional weekday versus weekend occupant patterns, a binary “weekday” flag is included. Together, these variables are used to predict the probability that an occupant is present in the home. The decision threshold to translate a predicted probability to a {0, 1} binary occupancy inference is initially set to 50%, while better estimates may be found using cross-validation on experimental data.

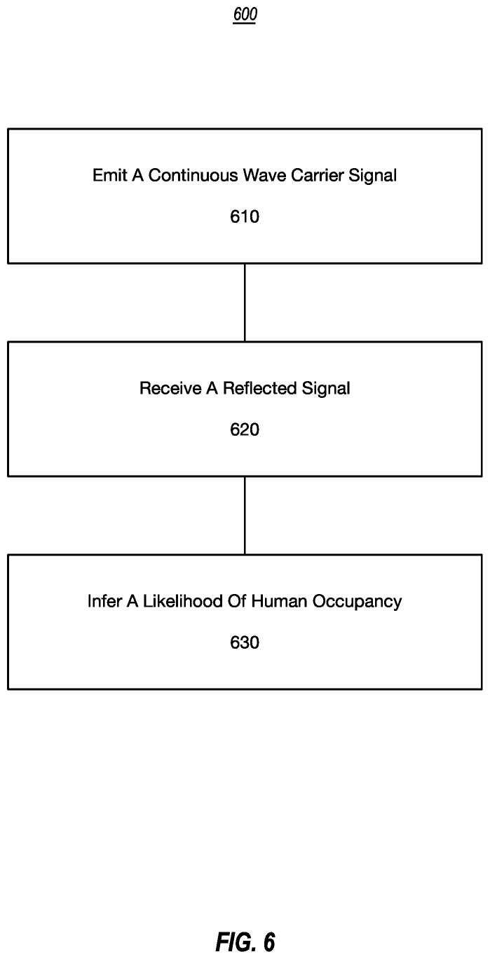

FIG. 6 illustrates a flowchart for a method 600 for wireless home identification and sensing. The method 600 includes an act 610 of emitting a continuous carrier wave. Act 610 comprises emitting from one or more base station units 110 a continuous wave carrier signal. The one or more base station units 110 are configured to be connected to a power source. The continuous wave carrier signal is configured to be received by one or more radio frequency identification (RFID) sensor nodes 120 that are configured to receive and reflect the continuous wave carrier signal. The one or more RFID sensor nodes 120 each including at least one of (1) an image sensor, (2) an acoustic energy sensor, (3) a temperature sensor, (4) an illuminance sensor, or (5) a relative humidity sensor. In at least one embodiment, the RFID sensor nodes 120 comprise environmental sensors (T, RH, illuminance) on a motherboard of each sensor node analyzed by STPN and, in addition, either an image or acoustic energy on the daughterboard 130. In at least one embodiment, an RFID sensor node 120 does not necessarily have to have a daughterboard 130 for either acoustic energy or images, but it may commonly have one. Accordingly, the T, RH, and illuminance environmental sensors may be present by default on the sensor node (motherboard). The addition of the daughterboard 120 can be viewed as optional.

Method 600 also includes an act 620 of receiving a reflected signal. Act 620 comprises receiving, at the one or more base station units 110, the reflected signal from the one or more RFID sensor nodes 120. For example, the RFID sensor nodes 120 may emit through an antenna sensor date to the base station 110. The transmitted signal may be powered by harvested power from the continuous wave carrier signal and/or a photovoltaic device. The RFID sensor nodes 120 reflect the data back utilizing backscatter communication techniques.

Further, method 600 includes an act 630 of inferring a likelihood of human occupancy. Act 630 comprises inferring, based on the reflected signal, a likelihood of human occupancy. As explained above, an autoregressive logistic regression may be used to determine a likelihood that a human occupant is within the building.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention is further described according to the following examples:

Example 1: An integrated occupancy sensing system, comprising: one or more radio frequency identification (RFID) sensor nodes, each of the one or more RFID sensor nodes including at least one of (1) an image sensor, (2) an acoustic energy sensor, (3) a temperature sensor, (4) an illuminance sensor, or (5) a relative humidity sensor; and one or more base station units, each of which is configured to be connected to a power source, wherein: when the one or more base station units are connected to a power source the one or more base station units are configured to emit a continuous wave carrier signal, the one or more RFID sensor nodes are configured to receive and reflect the continuous wave carrier signal, and the one or more base station units are also configured to: receive the reflected signal from the one or more RFID sensor nodes; and based on the reflected signal, infer a likelihood of human occupancy.

Example 2: The integrated occupancy sensing system of example 1, wherein at least one of the one or more RFID sensor nodes further includes a photovoltaic cell, and the at least one RFID sensor node is powered by a combination of the continuous wave carrier signal and the photovoltaic cell.

Example 3: The integrated occupancy sensing system of any of the above examples, wherein at least one of the one or more RFID sensor nodes does not include an energy storage component.

Example 4: The integrated occupancy sensing system of any of the above examples, wherein each of the one or more RFID sensor nodes includes an identical motherboard that provides power and communication to a corresponding RFID sensor node.

Example 5: The integrated occupancy sensing system of any of the above examples, wherein: at least one of the one or more RFID sensor node includes (1) a temperature sensor, (2) an illuminance sensor, and (3) a relative humidity sensor and a computer-readable storage that stores a machine-learned AI model for inferring likelihood of human occupancy based on data generated by the temperature sensor, the illuminance sensor, and the relative humidity sensor, and the machine learned AI model is a trained spatiotemporal pattern network (STPN).

Example 6: The integrated occupancy sensing system of any of the above examples, wherein each of the one or more RFID sensor nodes further includes one or more daughterboards, each of which provides a specific sensing modality.

Example 7: The integrated occupancy sensing system of any of the above examples, wherein: at least one of the one or more RFID sensor nodes includes an image sensor and a computer-readable storage that stores a machine-learned model for inferring likelihood of human occupancy based on data generated by the image sensor, and the machine-learned model is a trained convolutional neural network.

Example 8: The integrated occupancy sensing system of any of the above examples, wherein: at least one of the one or more RFID sensor nodes includes an acoustic energy sensor and a computer-readable storage that stores a machine-learned AI model for inferring likelihood of human occupancy based on data generated by the acoustic energy sensor, and the machine-learned AI model is a trained random forest classifier.

Example 9: The integrated occupancy sensing system of any of the above examples, wherein at least one of the one or more RFID sensor node includes (1) a temperature sensor, (2) an illuminance sensor, (3) a relative humidity sensor, and (4) either an image sensor or an acoustic energy sensor, and a computer-readable storage that stores a machine-learned AI model for inferring likelihood of human occupancy based on data generated by the temperature sensor, the illuminance sensor, and the relative humidity sensor, and the machine-learned AI model is a trained spatiotemporal pattern network (STPN).

Example 10: The integrated occupancy sensing system of any of the above examples, wherein at least one of the base station units is configured to: detect an electromagnetic interference signal within an electric distribution system of a building caused by electrical devices in the building; and infer the likelihood of human occupancy based on the electromagnetic interference signal.

Example 11: The integrated occupancy sensing system of any of the above examples, wherein: the at least one base station unit also includes a computer readable storage that stores a machine learned AI model configured to infer an overall likelihood of human occupancy based on the inferences of occupancy received from the one or more RFID sensor nodes, and the machine learned AI model is trained using an autoregressive logistic regression technique.

Example 12: A method for detecting human occupancy with a wireless sensing platform, the method comprising: emitting from one or more base station units a continuous wave carrier signal, the one or more base station units configured to be connected to a power source, wherein: the continuous wave carrier signal is configured to be received by one or more radio frequency identification (RFID) sensor nodes that are configured to receive and reflect the continuous wave carrier signal, the one or more RFID sensor nodes each including at least one of (1) an image sensor, (2) an acoustic energy sensor, (3) a temperature sensor, (4) an illuminance sensor, or (5) a relative humidity sensor; and receiving, at the one or more base station units, the reflected signal from the one or more RFID sensor nodes; and inferring, based on the reflected signal, a likelihood of human occupancy.

Example 13: The method of any of the above examples, wherein each of the one or more RFID sensor nodes comprises an identical motherboard that provides power and communication to a corresponding RFID sensor node.

Example 14: The method of any of the above examples, further comprising: receiving from at least one of the one or more RFID sensor nodes (1) a temperature sensor reading, (2) an illuminance sensor reading, and (3) a relative humidity sensor reading; and inferring, using a machine learned AI model that is a trained spatiotemporal pattern network (STPN), a likelihood of human occupancy based on data generated by the temperature sensor, the illuminance sensor, and the relative humidity sensor.

Example 15: The method of any of the above examples, wherein each of the one or more RFID sensor nodes further includes one or more daughterboards, each of which provides a specific sensing modality.

Example 16: The method of any of the above examples, further comprising: receiving from at least one of the one or more RFID sensor nodes an image sensor reading; and inferring, using a trained convolutional neural network, a likelihood of human occupancy based on data generated by the image sensor.

Example 17: The method of any of the above examples, further comprising: receiving from at least one of the one or more RFID sensor nodes an acoustic energy sensor reading; and inferring, using a trained random forest classifier, a likelihood of human occupancy based on data generated by the acoustic energy sensor.

Example 18: The method of any of the above examples, further comprising: receiving from at least one of the one or more RFID sensor nodes (1) a temperature sensor, (2) an illuminance sensor reading, (3) a relative humidity sensor reading, and (4) either an image sensor reading or an acoustic energy sensor reading; and inferring, using a trained logistic regression model, a likelihood of human occupancy based on data generated by the one or more RFID sensor nodes.

Example 19: The method of any of the above examples, further comprising: detecting an electromagnetic interference signal within an electric distribution system of a building caused by electrical devices in the building; and inferring the likelihood of human occupancy based on the electromagnetic interference signal.

Example 20: The method of any of the above examples, further comprising: inferring, using an autoregressive logistic regression technique, an overall likelihood of human occupancy based on the inferences of occupancy received from multiple RFID sensor nodes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An integrated occupancy sensing system, comprising:
one or more radio frequency identification (RFID) sensor nodes, each of the one or more RFID sensor nodes including at least one of (1) an image sensor, (2) an acoustic energy sensor, (3) a temperature sensor, (4) an illuminance sensor, or (5) a relative humidity sensor; and
one or more base station units, each of which is configured to be connected to a power source, wherein:
when the one or more base station units are connected to a power source the one or more base station units are configured to emit a continuous wave carrier signal,
the one or more RFID sensor nodes are configured to receive and reflect the continuous wave carrier signal, and
the one or more base station units are also configured to:
receive the reflected signal from the one or more RFID sensor nodes; and
based on the reflected signal, infer a likelihood of human occupancy.

2. The integrated occupancy sensing system of claim 1, wherein at least one of the one or more RFID sensor nodes further includes a photovoltaic cell, and the at least one RFID sensor node is powered by a combination of the continuous wave carrier signal and the photovoltaic cell.

3. The integrated occupancy sensing system of claim 1, wherein at least one of the one or more RFID sensor nodes does not include an energy storage component.

4. The integrated occupancy sensing system of claim 1, wherein each of the one or more RFID sensor nodes includes an identical motherboard that provides power and communication to a corresponding RFID sensor node.

5. The integrated occupancy sensing system of claim 4, wherein:
at least one of the one or more RFID sensor node includes (1) a temperature sensor, (2) an illuminance sensor, and (3) a relative humidity sensor and a computer-readable storage that stores a machine-learned AI model for inferring likelihood of human occupancy based on data generated by the temperature sensor, the illuminance sensor, and the relative humidity sensor, and
the machine learned AI model is a trained spatiotemporal pattern network (STPN).

6. The integrated occupancy sensing system of claim 4, wherein each of the one or more RFID sensor nodes further includes one or more daughterboards, each of which provides a specific sensing modality.

7. The integrated occupancy sensing system of claim 6, wherein:
at least one of the one or more RFID sensor nodes includes an image sensor and a computer-readable storage that stores a machine-learned model for inferring likelihood of human occupancy based on data generated by the image sensor, and
the machine-learned model is a trained convolutional neural network.

8. The integrated occupancy sensing system of claim 6, wherein:
at least one of the one or more RFID sensor nodes includes an acoustic energy sensor and a computer-readable storage that stores a machine-learned AI model for inferring likelihood of human occupancy based on data generated by the acoustic energy sensor, and
the machine-learned AI model is a trained random forest classifier.

9. The integrated occupancy sensing system of claim 6, wherein at least one of the one or more RFID sensor node includes (1) a temperature sensor, (2) an illuminance sensor, (3) a relative humidity sensor, and (4) either an image sensor or an acoustic energy sensor, and a computer-readable storage that stores a machine-learned AI model for inferring likelihood of human occupancy based on data generated by the temperature sensor, the illuminance sensor, and the relative humidity sensor, and
the machine-learned AI model is a trained spatiotemporal pattern network (STPN).

10. The integrated occupancy sensing system of claim 1, wherein at least one of the base station units is configured to:
detect an electromagnetic interference signal within an electric distribution system of a building caused by electrical devices in the building; and
infer the likelihood of human occupancy based on the electromagnetic interference signal.

11. The integrated occupancy sensing system of claim 1, wherein:
the at least one base station unit also includes a computer readable storage that stores a machine learned AI model configured to infer an overall likelihood of human occupancy based on the inferences of occupancy received from the one or more RFID sensor nodes, and
the machine learned AI model is trained using an autoregressive logistic regression technique.

12. A method for detecting human occupancy with a wireless sensing platform, the method comprising:
emitting from one or more base station units a continuous wave carrier signal, the one or more base station units configured to be connected to a power source, wherein:
the continuous wave carrier signal is configured to be received by one or more radio frequency identification (RFID) sensor nodes that are configured to receive and reflect the continuous wave carrier signal, the one or more RFID sensor nodes each including at least one of (1) an image sensor, (2) an acoustic energy sensor, (3) a temperature sensor, (4) an illuminance sensor, or (5) a relative humidity sensor; and
receiving, at the one or more base station units, the reflected signal from the one or more RFID sensor nodes; and
inferring, based on the reflected signal, a likelihood of human occupancy.

13. The method of claim 12, wherein each of the one or more RFID sensor nodes comprises an identical motherboard that provides power and communication to a corresponding RFID sensor node.

14. The method of claim 13, further comprising:
receiving from at least one of the one or more RFID sensor nodes (1) a temperature sensor reading, (2) an illuminance sensor reading, and (3) a relative humidity sensor reading; and
inferring, using a machine learned AI model that is a trained spatiotemporal pattern network (STPN), a likelihood of human occupancy based on data generated by the temperature sensor, the illuminance sensor, and the relative humidity sensor.

15. The method of claim 13, wherein each of the one or more RFID sensor nodes further includes one or more daughterboards, each of which provides a specific sensing modality.

16. The method of claim 15, further comprising:
receiving from at least one of the one or more RFID sensor nodes an image sensor reading; and
inferring, using a trained convolutional neural network, a likelihood of human occupancy based on data generated by the image sensor.

17. The method of claim 15, further comprising:
receiving from at least one of the one or more RFID sensor nodes an acoustic energy sensor reading; and
inferring, using a trained random forest classifier, a likelihood of human occupancy based on data generated by the acoustic energy sensor.

18. The method of claim 15, further comprising:
receiving from at least one of the one or more RFID sensor nodes (1) a temperature sensor, (2) an illuminance sensor reading, (3) a relative humidity sensor reading, and (4) either an image sensor reading or an acoustic energy sensor reading; and
inferring, using a trained spatiotemporal pattern network (STPN), a likelihood of human occupancy based on data generated by the one or more RFID sensor nodes.

19. The method of claim 12, further comprising:
detecting an electromagnetic interference signal within an electric distribution system of a building caused by electrical devices in the building; and
inferring the likelihood of human occupancy based on the electromagnetic interference signal.

20. The method of claim 12, further comprising:
inferring, using an autoregressive logistic regression technique, an overall likelihood of human occupancy based on the inferences of occupancy received from multiple RFID sensor nodes.
